(19) United States
(12) Patent Application Publication
(10) Pub. No.: US 2006/0273235 A1
(43) Pub. Date: Dec. 7, 2006

(54) Sidewall system for a casting mold

(75) Inventors: Leo Sandqvist, Forssa (FI); Aimo Seppanen, Saaksmaki (FI)

Correspondence Address: BUCHANAN, INGERSOLL & ROONEY PC, POST OFFICE BOX 1404, ALEXANDRIA, VA, 22313-1404, US

(73) Assignee: Consolis Technology Oy Ab, Vantaa (FI)

(21) Appl. No.: 11/439,962

(22) Filed: May 25, 2006

(30) Foreign Application Priority Data
Jun. 1, 2005 (FI) 20050583

(51) Int. Cl. B28B 7/34

(52) U.S. Cl. 249/134

(57) ABSTRACT

A sidewall system of a casting mold to be fixed detachably to a casting bed, especially to be used with a sidewall robot, said sidewall system comprising a sidewall element (1) and a magnet unit (3) for fixing the sidewall element to the casting bed, whereby one or a plurality of auxiliary magnets (2) have been located to the sidewall element (1), to the surface of the sidewall element setting against the casting bed.

The present invention relates to casting molds formed of sidewalls that are fixed detachably to a casting bed. More specifically, the present invention relates to sidewall systems used in casting molds and positioned onto the casting bed by means of a sidewall robot.

There are many different sidewall systems known in the art. Traditionally, the sidewalls forming the casting mold are positioned onto the casting bed to desired places and they are fixed in place by means of magnets. Correspondingly, apertures and cavities are formed to the element to be cast by means of sidewalls to be positioned inside the mold.

European patent EP 1 075 917 discloses a magnet unit for fixing sidewalls of a mold to the casting bed. In the solution disclosed in this publication, the face surface of the magnet unit is provided with a protruding part having at its lower edge a wedge surface adapting to the corresponding groove at the outer surface of the sidewall. Thus, the attachment of the magnet to the casting bed causes the sidewall to be pressed tightly in its place against the casting bed.

On the other hand, such sidewall systems are known, where the fixing magnet of the sidewall is located inside the sidewall, the magnet forming thus a part of the sidewall construction. In these sidewall systems the sidewall is removed from the casting bed by lifting or turning the magnet inside the sidewall. This kind of solutions have been disclosed among others in the European patent publication EP 0 639 682 and in the European patent publication EP 1 352 723, also suitable to be operated with a sidewall robot.

Sidewall robot in this connection refers to an automated device for positioning and fixing the sidewall elements onto the casting bed in desired places so as to form a casting mold onto the casting bed.

In the present invention, the sidewall of the casting bed is formed of a light-weight sidewall element having auxiliary magnets located to the joint surface setting against the casting bed. By means of said auxiliary magnets, the light sidewall elements keep accurately to their places when positioning them to their final places on the casting bed. The sidewall construction of the present invention is especially advantageous in the manufacture of molds implemented by means of sidewall robots. The sidewalls are finally fixed to their places by means of separate magnet units, like with a magnet unit described for example in the Patent publication EP 1 075 917, said attachment being advantageously implemented by means of a sidewall robot.

By means of a sidewall solution according to the invention, the sidewall elements can be positioned to their final places without a fear, that the elements would move away when positioning other elements to their places, especially when using a sidewall robot. In addition, the sidewall system according to the invention can be manufactured of substantially lighter materials and with a more simple construction than the sidewall elements known in the art.

More specifically, the sidewall system according to the present invention is characterized by what is stated in the characterizing part of claim 1.

The invention will be described by way of example in more detail in the following, with reference to the enclosed drawings, wherein

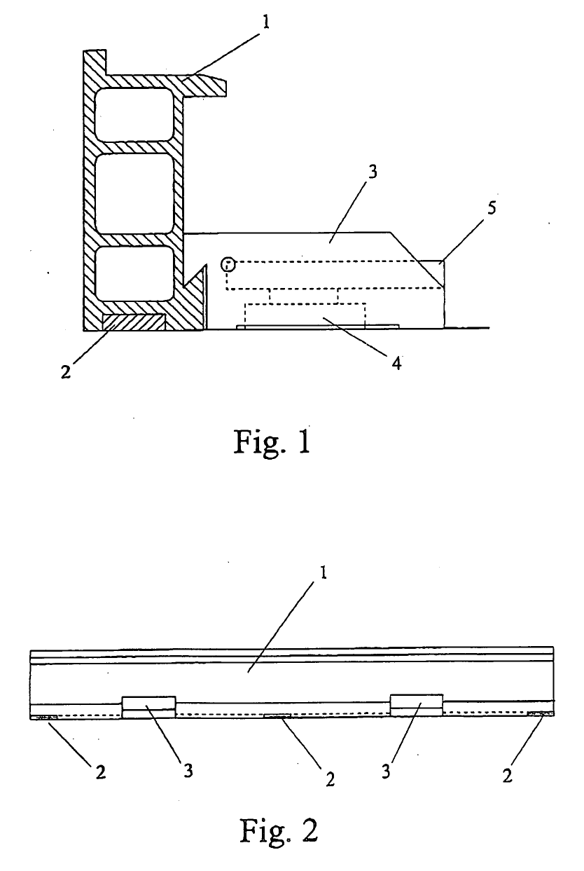

FIG. 1 shows a side view of one sidewall system in accordance with the invention, and

FIG. 2 shows a back view of a sidewall system in accordance with the invention.

A sidewall system according to the present invention shown in FIG. 1 comprises a light-weight sidewall element 1, an auxiliary magnet or auxiliary magnets located to the bottom of the sidewall element and a magnet unit 3 fixing the sidewall element to the casting bed for the duration of the cast.

When positioning the sidewall element 1 to its place, the auxiliary magnet 2 on the bottom thereof fixes the sidewall element 1 to its final place preventing it from falling down and from moving from its place when the other sidewall elements forming the casting mold are being positioned onto the casting bed. The final attachment of the sidewall element 1 to its place is implemented by means of a magnet unit 3. The keyway on the back wall of the sidewall element 1 adapts to the correspondingly chamfered groove of the lower edge of a protrusion formed in the face surface of the magnet unit 3, whereby the attachment of the magnet unit 3 by means of its magnet 4 to the casting bed also makes the sidewall element 1 fix tightly to the casting bed. The fixing and detaching of the magnet unit 3 is implemented by means of a lever 5 connected to the magnet 4.

The keyway pair of the sidewall element 1 and the magnet unit 3 also causes the magnet unit 3 to be correctly positioned with respect to the sidewall element 1, because the pair of keyways guides the magnet unit 3 to fix to the sidewall element before the magnet unit 3 is locked in its place. The auxiliary magnets 2 ensure the fixing of the sidewall element 1 in place when the magnet unit is guided to capture the back wall of the sidewall element. This feature substantially improves the use of the sidewall system according to the invention when forming the casting mold implemented with sidewall robots.

A magnet unit that is operable without problems by means of a sidewall robot is preferably chosen to be used as a magnet unit 3 in the sidewall system.

FIG. 2 shows a back view of one sidewall system according to the invention, describing an example of the positioning of the auxiliary magnets 2 and the magnet units 3 with respect to the sidewall element 1. A desired amount of auxiliary magnets can be located to the bottom of the sidewall element for achieving a desired fixing effect. Preferably the auxiliary magnets to be used have such a fixing effect, that they can be readily detached from the casting bed manually, without special tools.

In the sidewall system according to the invention, the light-weight sidewall element 1 is preferably manufactured for example of aluminium, extruded wood pulp or plastic.

1. A sidewall system of a casting mold to be fixed detachably to a casting bed, especially to be used with a sidewall robot, said sidewall system comprising a sidewall element (1) and a magnet unit (3) for attaching the sidewall element to the casting bed, wherein in the sidewall element (1), one or a plurality of auxiliary magnets (2) are located to the surface of the sidewall element to be set against the casting bed.

2. A sidewall system according to claim 1, wherein the back wall of the sidewall element (1) is equipped with a wedge-shaped groove and the face surface of the magnet unit (3) is equipped with a protrusion, said protrusion comprising a mating surface adapting to said wedge-shaped groove.

3. A sidewall system according to claim 1, wherein the auxiliary magnets located to the sidewall element (1) have a fixing effect enabling the manual detachment of the assembly.

4. A side system according to claim 1, wherein the sidewall element (1) is manufactured of an aluminium profile, extruded wood pulp or plastic.

5. A sidewall system according to claim 2, wherein the auxiliary magnets located to the sidewall element (1) have a fixing effect enabling the manual detachment of the assembly.

6. A side system according to claim 2, wherein the sidewall element (1) is manufactured of an aluminium profile, extruded wood pulp or plastic.

7. A side system according to claim 3, wherein the sidewall element (1) is manufactured of an aluminium profile, extruded wood pulp or plastic.

8. A side system according to claim 5, wherein the sidewall element (1) is manufactured of an aluminium profile, extruded wood pulp or plastic.
